(19) United States
(12) Patent Application Publication
(10) Pub. No.: US 2019/0135494 A1
(43) Pub. Date: May 9, 2019

(54) FROZEN FISH BLOCK PACKAGES AND METHODS FOR PRODUCING AND USING THE PACKAGES

(71) Applicant: FLEXINNOVA KFT, Fot (HU)

(72) Inventors: Zoltan MANDZSU, Budapest (HU); Jozsef MANDZSU, Budapest (HU); Jozsef MANDZSU, Fot (HU)

(21) Appl. No.: 16/304,506

(22) PCT Filed: May 5, 2017
(86) PCT No.: PCT/HU2017/000032

§ 371 Date: Nov. 26, 2018

(30) Foreign Application Priority Data
May 26, 2016 (HU) P1600339

(51) Int. Cl. B65D 33/00

(52) U.S. Cl. CPC B65D 33/005; B29K 2995/0072

(57) ABSTRACT

A stackable package includes a packaging sack and a block of plate-frozen fish packed therein. The sack is a plastic sack having a second outer surface, on which the package can be laid on a stack, and an opposing first outer surface. A roughened surface-part of the first outer surface includes antislip protrusions projecting from a first wall of the sack. A skidproofed surface-part of the second outer surface includes a skidproofing material, of a suitable fibrous structure, fixed to a second wall of the sack. The skidproofing material is capable of a nonslip bond with the antislip protrusions. The sack has a wear rate of between 0 and 0.35. The wear rate is determined in a wear-rate test in which (at a temperature of −20° C. and a compression of 11557 Pa) a specimen of the skidproofed surface-part is slided on a roughened surface-part specimen and the wear rate is defined as the proportion of the number of anstislip protrusions breaking off the roughened surface-part specimen due to the slide. Accordingly, multiple packages can be manually re-stacked without losing too many of their antislip protrusions.

### FIELD

The invention relates to packages of plate-frozen fish blocks packed in antislip plastic packaging bags, methods for producing the packages and methods for using the packages. In this document, the term fish also includes other seafoods caught from sea or other waters.

### BACKGROUND

Fishing vessels spend long times at sea. For keeping the catch fresh, fish are block-frozen on board, typically in a semi-processed (headed-and-gutted, filleted etc.) state. The fish is frozen very quickly, for keeping its quality, therefore plate freezing is used. Fish are filled in between two essentially parallel (e.g., either vertical or horizontal) flat freezing plates having a positive contact with the fish block that force the fish block to lose heat as fast as possible. The distance between the two freezing plates is small (typically 10 cm), for a fast freezing-through of the fish block. That is why plate-frozen fish blocks are flat in shape, with essentially smooth, planar and parallel, top and bottom surfaces, laid on which the blocks can be stacked, having a block height of about 10 cm. A typical standard plate-frozen fish block of 25 kg has a shape similar to a rectangular parallelepiped of dimensions of 53 cm×53 cm×10 cm. For preventing the frozen fish from oxidizing, the blocks are packed in bags of kraft paper with a plastic lining. The packages are stored, piled up in stacks, in the refrigerated hold of the vessel. The stacks usually have a columnar pattern.

We analysed and found that the practice of packaging the plate-frozen fish blocks has special circumstances that result from the packaging and storing happening on board of a vessel, at sea, as follows. Air relative humidity in the packaging room may be about 100 percent. Stacking, storing and handling of the packages happens on a floor that is vibrated and tilted, in random directions, as sea waves hit the vessel. In addition, the stacked packages about each other with their hard, flat and smooth surfaces, and all that necessitates a skidproofness of the bags. Further, we found that each package will be probably put on top of another package and removed therefrom repeated several times during its lifetime. Namely, for example, some packages are temporarily put on top of each other in the elevator that takes them down from the packaging room to the hold. That temporary stack is then taken apart (packages removed from each other) when each package is put on top of the newly-built stacks in the hold area. Later, on unloading the vessel, the stacks are taken apart (packages removed one by one from each other) and then re-stacked on the shore in the harbour. Often the whole lot is re-stacked again later in order of a sorting of the goods, for which sorting there is not enough time at sea. We found that even with the highest level of packaging and handling automation, packages are typically manually re-stacked at least once during their lives, which number can, in case of smaller fishing vessels, even reach five. That is possible to do with the kraft paper bags. On the other hand, plastic-lined kraft paper bags have drawbacks: they are not environmentally friendly, are not recyclable; also, the packaging supply is relatively bulky to store.

On the other hand, recyclability and a low bulk of the packaging supply are known to be easily provided with plastic bags. Normal plastic bags, however, have a far too low coefficient of friction for this purpose. In search of a recyclable solution, it is reasonable for the skilled person to look for an existing plastic antislip bag design especially designed for frozen food products whose antiskid behaviour is for example based on a surficial mechanical interlock. U.S. Pat. No. 4,488,918 discloses for frozen-food packaging a plastic bag whose film has a non-slip surface comprising spaced random patterns of rigid peaks and ridges, formed by rupturing an outer polymer layer in its coextrusion. In the focus of the patent is the coefficient of friction, considered to be the clue to nonskid frozen-food packaging. The patent reports its film to have a coefficient of friction of 0.45 to 0.65. A solution of an even stronger mechanical interlock is mentioned in publication HU0202948A2 (titled “Skidproof packing method and skidproof frozen package”). The document refers to the patent family of U.S. Pat. No. 6,444,080 B1 as containing further background teaching specific to its solution, thus we are considering these two background documents in combination, as follows. In case of conflict, the present specification, including definitions, will control.

U.S. Pat. No. 6,444,080 B1 teaches a system comprising two films (preferably on top and bottom of a package sack, respectively) to be fixed against slipping on each other, the first film being roughened and the second film provided with a binding element fixed to the second film, where such a roughened film is applied that has, on its surface, antislip protrusions having suitable closeness and geometric features with respect to the binding element, and the binding element has a loose fibrous structure and individual fibre-stability and comprises fibres of such closeness and layer thickness that between the fibres of the binding element and the protrusions of the roughened film a mechanical joint can be formed. The binding element can be an airy nonwoven fabric of a sufficient fibre strength, for example. For a better interlock, the antislip protrusion has an undercut which can hook the fibres of the binding element in case of a lateral shearing stress arising between the films. A plastic film can be made suitably rough, for example, by adhering particles to the film with an adhesive, or by heating the film to a softening point and then spraying onto it plastic powder particles preferably able to weld to it, as is taught by U.S. Pat. No. 6,444,080 B1 or, e.g., by DE4207210A1. The material of the particles should be selected such that their abrasion resistance is suitably great for this purpose. U.S. Pat. No. 6,444,080 B1 reports that the system is able to stabilize heavy duty pellet- and animal-feed-packages stacked on pallets without pallet wrapping in case the pallets are kept horizontal and exposed to vibration from road transport. It also reports that the horizontal shear strength within its gripping-film-pair is fairly significant already at very little normal surface pressure (while static frictional force between conventional surfaces decreases proportionally with the pressure) and even the compressing force repeatedly dropping near to zero is not detrimental to the stability. It also reports that the bond between the binding element and the roughened film prevents any slipping along the surface. The surfaces can be vertically lifted off each other without extra effort and replaced onto each other, many times without damage, for example at a manual re-stacking. The document teaches about a mutual dimensioning of the antislip protrusions and the fibrous binding element as follows. According to the document the roughening protrusions preferably comprise polyethylene or polypropylene, and the binding element can comprise polyethylene or preferably polypropylene, polyester or polyamide. The fibrous structure of the binding element must be strong enough: fibres must have suitable individual stability to prevent the protrusions from tearing them apart when stress in the direction of slipping arises. In all of its examples, the area of the fibrous engaging surface of a package is smaller than that of the mating roughened engaging surface. Namely because, as we have found, the manufacturing costs (per area cm²) of a suitable fibrous nonwoven component fixed to the surface are greater than those of a surface-roughening.

The improvement by HU0202948A2, over U.S. Pat. No. 6,444,080 B1, consists in optimizing the antislip plastic bag solution of U.S. Pat. No. 6,444,080 B1 to the packaging of frozen foods. The recognition in HU0202948A2 is that the cold bag wall of a frozen-food package may precipitate moisture from the surrounding air and therefore white frost will build up on the rough outside surface of the film and as soon as its thickness reaches the top of the undercut-part of an antislip protrusion, that protrusion loses its ability to interlock with the binding element fibres in the way it did earlier which leads to a deterioration of the effective static coefficient of friction of the system. HU0202948A2 teaches that the undercut of the antislip protrusion should be as high as possible, but at least 10 micrometres, preferably e.g. 110-130 micrometres. In its example the antislip protrusions are constituted by polyethylene reactor (i.e., made-by-precipitation) powder granules welded to the film. The document prompts the skilled person to use spherical granules to make undercut protrusions looking like small water droplets resting on a non-wettable surface. The document does not deal with flat-surfaced plate-frozen meat blocks. The skilled person will understand that HU0202948A2 aims to improve the art of U.S. Pat. No. 6,444,080 B1 with suggesting that if the antislip system is used for packing frozen food then, on manufacturing the roughened film with spraying and fixing powder granules to the film-to-be-roughened, one should refrain from embedding the granules deeply but, instead, one should provide for a sticking-out of the (preferably sphere-like) granules from the surface as high as possible, with an inherently small contact area remaining to keep it in fixation with the film.

Both U.S. Pat. No. 6,444,080 B1 and HU0202948A2 aim to maximise static coefficient of friction between film portions that are not meant to ever be actually slipped up on each other during their lives. Their teaching leads to films whose static coefficient of friction we measured to readily be higher than 10, at a pressure available under a top sack-package (e.g., of fertilizer or animal feed) in a stack. That very high value makes it easier, on dismantling a stack, to completely lift up or, even better, roll down the top package from the stack (the latter also corresponding to a vertical separating motion on the micro-scale in respect of the gripping elements) than trying to pull and slide off the top package horizontally, the latter possibly requiring a pulling force equalling a multiple of the package weight, which could lead to back injuries. Thus, in the cited documents, a horizontal shifting of the gripping surface portions is not expected to happen, because it is neither feasible nor necessary while a vertical separation thereof is easy and obvious, and that combination provides that the antislip qualities of the gripping film portions remain in good quality even after a series of repeated manual re-stacking, not necessitating gripping surfaces able to survive an actual slide in good quality. The only reference in the documents, as to what might happen in case of an actual slippage, is the above-mentioned teaching of U.S. Pat. No. 6,444,080 B1 that the fibres of the binding element must have suitable individual stability to prevent the particles from tearing it apart and the fibres from slipping off it when stress in the direction of slipping arises. It suggests to the skilled person that even if a slipping should occur, the fibres of the binding element must not break.

Further, granted Hungarian patent HU222597B1, corresponding to WO99/36263, teaches about a polypropylene fabric with an antislip plastic layer comprising protrusions welded into and at least partially sticking out of the surface, consisting of the substance of the antislip layer and/or other particles capable of welding with the material of the antislip layer, wherein the antislip layer is fixed to the polypropylene fabric by coating in a moulded condition.

Further, providing, for a testing of frictional behaviour of plastic films, a sled, and taking specimens of the films, and sliding a specimen on another specimen with the sled with a standard sled length, sled displacement, pressure and temperature, and aiming at a standard evaluation are known from the standard ISO 8295. Further, a simple inclined-plane-type test popular for measuring the static friction of packaging materials is described in the standard TAPPI T 815. Its use is advantageous because it directly shows how steep an incline a package can withstand without sliding.

There is still a need for a safe and effective antislip plastic flexible packaging of plate-frozen fish blocks, including a need for stackable packages, and for methods for producing and for using the stackable packages. In the technical prejudice this task would correspond to that solved by HU0202948A2 in combination with U.S. Pat. No. 6,444,080 B1. Technical prejudice would prompt the skilled person to provide in each cm² of contact between the respective rough and fibrous gripping components the greatest possible specific static coefficient of friction, resisting the frost precipitation for the longest possible time. Therefore, the skilled person would provide a nonwoven fabric with the strongest possible fibres, preferably a polyester or polyamide nonwoven if necessary, and would select antislip protrusions, of a hard and abrasion-resistant polymer, providing the highest free undercuts (for a long-time resistance to the frost-precipitation). As a result, the skilled person would expect the system to provide a safe nonslip packaging system that can be re-stacked many times without any harm done to the antislip gripping components.

### SUMMARY

Our recognition includes that we realised that a new and non-obvious feature must be introduced, over the mentioned technical prejudice, in order that a slip resistance is reliably maintained even after a manual-re-stacking of the plate-frozen fish block packages. Namely, in a vessel the refrigerated hold must be filled in, with packages, nearly to its 100% room volume capacity which results in stacks possibly being as high as, or even higher than, a worker's height. When the worker has to remove the uppermost 25-kg fish block package from the top of the stack, he will naturally find it impossible to horizontally pull the uppermost fish block package in a horizontal orientation thereof (like a drawer in a chest of drawers), because that would need a pulling force being a multiple of the package weight. Further, a rolling-off of the top package is not possible either, because the package is flat, rectangular and not flexible. The worker will find it possible, to vertically fully lift the whole fish block package before displacing it horizontally, but somewhat difficult because of its elevated position and its special shape. But, as we recognised, the hardness and flat, parallelepiped-shape of the package can make it possible for the worker to lift, a couple of cm's, one horizontal edge of the package, holding with his hands about a half of the package weight, letting the package simultaneously rest on its opposing, parallel edge with the other half of its weight. As we found, in this configuration a 25-kg package of headed-and-gutted fish block sits on the top of the lower package with an abutting surface of a width of about 53 cm (the fish block width) and an average length of about 2 cm, this narrow abutting surface bearing about a half of the 25-kg weight of the package, that corresponding to an average pressure of 11557 Pa. If the worker maintains this orientation of the package and simultaneously exerts a horizontal pulling to the package then the package can be slid with a feasible effort. (This is illustrated in Example 7, FIG. 22.) As we recognised, this is a new and surprisingly feasible manner of removing a top fish block package from the top of a high stack if the packages are stabilised with the special gripping pair of films as detailed above. The gripping pair of “rough film+fibrous binding element” has a certain maximum load-bearing capability (i.e. shear strength) which means a greatest horizontal shear stress (i.e. shear-force-per-abutting-surface-area) that they can resist without slipping. Plate-frozen fish block is a surprising case in which it is feasible for a worker to actually exert such a great local shear load and actually slide the films on each other when removing a package from a stack. That is possible because, in this special case, particularly for example in the case of vertically-plate-frozen blocks of unfilleted (e.g., headed-and-gutted) fish, the worker can simply reduce the abutting surface of the package to the approximately 2-cm-long area adjacent the package-edge abutting on the lower package(s). And the force necessary to overcome the static frictional force generated by the gripping of that small abutting area is low enough to possibly make this operation easier for the worker than to vertically lift the whole package. Thus, we recognised that, unlike in the antislip packages known from the background art, the gripping film portions in the plate-frozen fish block packages will probably undergo a (possibly: repeated) mutual slide (and under an extraordinarily great pressure) while the packages are re-stacked. We recognised that it gains significance to select such new parameters in the rough/fibrous gripping pair that (in addition to providing a sufficient static friction) provide an antislip system that retains (to a sufficient extent) its static friction capability even after the above-described sliding occurs. We found that it is better to place the fibrous (i.e., the more expensive, therefore usually smaller-sized) binding component to the lower side of a package than the roughened one, because if the downward-looking fibrous gripping surface is small enough to leave a neighbourhood of the lower package edges free, it can even be possible to slide a portion free of the fibrous binding element, of the downward-looking bag wall, which is easier (however a natural slack of the sack, or a dependence thereof on an orientation of the top package relative to its pulling direction, can make that uncertain to achieve). That results in our essential recognition element, that for sacks used with plate-frozen fish blocks such a “roughened+fibrous” gripping pair should be selected in which a 2-cm-long portion of the fibrous binding element of the package bottom, sliding across the mating roughened surface of the whole package top, does not spoil the latter too much. We recognised that an effect of the sliding must be evaluated at the real-life pressure and at the real-life cold (−20° C.) temperature because both have great influence on the mutual behaviour of the interacting protrusions and fibres. Namely, polymers used for packaging sacks, i.e., particularly polyolefins are known to show a definite increase in modulus and tear strength if the temperature is taken from 18° C. to −20° C., especially if their glass transition temperature is typically between 18° C. and −20° C., as is the case with polypropylene. To illustrate this, see Example 1. That difference in modulus and tear strength, depending on the temperature, will inevitably greatly influence the way the fibres stretch or break and the films bend and the protrusions get deformed or break. We gained an insight into the nature of how a fibre or yarn of the binding element hooked around a mating antislip protrusion can get released when the packages are slid on each other. The film carrying the protrusion can bend at the foot of the protrusion (if the film is flexible enough and an undercut of the protrusion is not too emphasised) so that the protrusion releases the fibre or yarn, providing a reversible manner of the releasing, though in such cases the shear strength is necessarily lower, therefore such dimensioning is against the technical prejudice. On the other hand, if the film does not bend enough, the protrusions can get deformed, can (temporarily or finally) lose their original shapes in response to the stress from the fibre or yarn hooked on them. Protrusions from softer polymers can more easily do it without breaking than those from harder polymers (though the latter are taught in the background art to be preferred as abrasion-resistant materials, in fact providing greater shear strength values). And finally, it can happen that either a protrusion or a fibre or yarn must break, for the releasing. The background art, as we mentioned above, teaches that in such cases the fibre or yarn must not be torn apart, therefore it is the protrusion that must break. We, however, recognised that it can be beneficial to select an opposite approach. The gripping performance is based on many individual bonds, each typically involving one free fibre section and one antislip protrusion. It would be beneficial to save as many individual bonds as possible, for the future, when the surfaces are slid with a shear overload. We found that in practical examples, in a cm² of the respective facing gripping materials there are in fact much more free fibre- or yarn-sections available than antislip protrusions (especially if the protrusions are relatively big, therefore few/cm², as is taught in the background art for resisting the white-frost buildup). It leads to the fact that the number of available individual bonds practically equals the number of antislip protrusions, in the area. For our current objective, it means that once something must break, then it should be the fibre or yarn that breaks, rather than the protrusion. Namely, that does not reduce the number of possible bonds, available in future connections, as long as there are still enough of the many free fibre sections left intact.

Thus, the essence of a package invention is a stackable package, comprising
a packaging sack and a block of plate-frozen fish packed therein,
the package being new in that
the sack is a plastic sack having a second outer surface, on which the package can be laid on a stack, and an opposing first outer surface, and
   at least a part, the roughened surface-part, of the first outer surface comprising antislip protrusions projecting from a first wall of the sack, and
   at least a part, the skidproofed surface-part, of the second outer surface comprising a skidproofing material, of a loose, fibrous structure, fixed, at least against slipping, to a second wall of the sack, which skidproofing material is capable of a nonslip bond with the antislip protrusions due to the antislip protrusions having suitable closeness and geometric features with respect to the skidproofing material and due to the skidproofing material including filaments or yarns in a density and layer thickness at which a mechanical bond can be formed between the filaments or yarns and the antislip protrusions,
   the sack being suitable to pass a wear rate test with a result of a wear rate of between 0 and 0.35,
   the wear rate test comprising the steps of
      providing a sled,
      the sled having a rectangular flat surface on which the sled is suitable to slide in a sliding direction, the flat surface having a flat surface length of 20 mm parallel with the sliding direction, and a flat surface width of at least 20 mm in a direction perpendicular to the sliding direction,
      providing a sled assembly by covering the sled flat surface in a suitably selected specimen of the sack second wall with the skidproofed surface-part providing a sliding surface of the sled assembly,
      in a wearing operation bringing the sliding surface into a face-to-face relationship with a first area of a suitably selected specimen of the roughened surface-part and then maintaining a temperature of −20° C. in the sliding surface and the roughened surface-part specimen and a normal compression of 11557 Pa between them while sliding 40 mm's in the sliding direction the sled assembly on the roughened surface-part specimen for bringing the sliding surface into a face-to-face relationship with a third area of the roughened surface-part specimen,
      in the roughened surface-part specimen the first area and the third area defining a second area therebetween, having antislip protrusions,
      recording a first protrusion number equalling a number of the antislip protrusions available in the second area before the sliding and having a top-plan-view size greater than a limit size, the limit size being a half of an average of the respective top-plan-view sizes of each antislip protrusion available in the second area before the sliding,
      recording a second protrusion number equalling the number of the antislip protrusions available in the second area after the sliding and having a top-plan-view size greater than the limit size,
      defining the resulting wear rate equalling a difference, between the first protrusion number and the second protrusion number, divided by the first protrusion number.

The package can be stacked in a columnar pattern or in brick-bond pattern or in any suitable way. The term fish also includes other seafoods caught from sea or other waters. The block is a block made by plate-freezing as can be recognised for example from its flat shape typical of sea-frozen fish blocks. Vertical plate freezing is popular with unfilleted, e.g., headed-and-gutted fish in which case the sides of the block are sometimes irregular, exposing parts of individual fish bodies, which provides edges of the block not being quite sharp and straight but somewhat rounded, a radius thereof corresponding to individual fish body geometry. It is possible to wrap the block into one or more layers, e.g. thin plastic films, before packaging the block into the sack. The block can include ice glazing. One sack can contain one or two, or three, or more blocks. The sack is a plastic sack, including one or both of suitable synthetic and natural polymers, and can include any one or more of films, laminates, nonwoven fabric, woven fabric, e.g., a fabric woven from film tapes (e.g., a circularly-woven or flat-woven fabric) with or without an internal and/or external coat made for example with extrusion coating etc. The sack can be a pre-manufactured individual sack or one made from one or more reels of packaging material when the packaging is done (so called FFS, Form-Fill-Seal, sack). The sack can also contain components other than plastic, e.g., in the form of printing, labels, inserts etc. The packing of the block into the sack can happen manually or partly or fully mechanised. The mouth of the sack can be left open after the packaging or can be closed, e.g., with welding or gluing, adhering, sticking, taping, sewing etc. Welding can be done for example with hot-air, hot-bar, patterned-hot-bar, hot-wire, patterned-hot-wire, ultrasonic, impulse, patterned-impulse or any other suitable welder. Providing a cooling time for each welding can be a part of the closing. The welded area can consist of disjunct islands of welded micro-portions (corresponding, e.g., to a pattern of the patterned welding tool) which is preferable with welding fabrics woven from flat tapes in order of keeping them from shrinking from the welding and in order of providing flat tape portions left unwelded for a more secure load bearing. The welding or sewing line can fix one or more gussets in a gusseted configuration, with more plies locally, or the gussets can be partly or fully pulled out flat (folded out) before closing the mouth. On stacking, the block is to be laid on one of its major flat sides. In such a stacked configuration, the sack has two usually flat outer surfaces, the first outer surface looking up ready to contact packages to be put on the stack later and the second outer surface looking downward contacting package(s) one layer lower in the stack. A part or possibly even the whole of the first outer surface is roughened. There is at least one roughened surface-part in it though it can as well include more such surface-parts, interconnected or separate, in any useful configuration, e.g., in stripes, spots etc. Some regions can be left without roughening in order, for example, of a later stamping, writing-on or labelling. The first wall can include one layer or more layers, a plurality of layers can be attached to each other fully or partly, e.g., in patterns, the layers can be uniform, or similar, or different from each other e.g., providing the wall with different properties (e.g., blocking moisture, blocking ultraviolet light, giving strength, blocking oxygen, absorbing moisture, providing aesthetics, providing printable or adhereable or sealable inner or outer surface, etc.). The protrusions project from the wall and the wall can for example provide a flat base surface around a projecting protrusion or the wall can be non-planar, e.g., can provide a bump or an indentation at a foot of the protrusion or the wall can have an outer surface with a texture, e.g., in case of woven (coated or uncoated) fabrics. A part or possibly even the whole of the second outer surface is skidproofed. There is at least one skidproofed surface-part in it though it can as well include more such surface-parts, as mentioned in regard of the roughed surface-parts. The skidproofing material has a suitable fixation with the second wall of the sack. The fixation provides for the skidproofing material suitably fixed to the second wall at least against a slipping-up on the second wall and preferably (but not necessarily) also against a peeling from and/or lifting from the second wall. The fixation against a slipping-up on the second wall preferably includes providing antislip protrusions projecting from the second wall and keeping the skidproofing material from slipping up on the second wall. The optional fixation against a peeling or lifting of the skidproofing material can for example be based on sewing, adhering, sticking, with a pressure sensitive adhesive or with a crosslinked adhesive, with a hot melt or a low melt adhesive, or e.g. with extrusion lamination, or the skidproofing material can be welded to the sack wall (e.g., with extrusion welding, hot bar, ultrasonic or any other suitable welding). It is also possible that the skidproofing material is unitary with the second wall, for example, the second wall contains a layer, such as a nonwoven or other fabric layer, suitably acting as a skidproofing material, possibly after a napping thereof. The second wall can further include one or more layers, similarly to the first wall. The skidproofing material has a suitable loose fibrous structure which in practice will for example mean that it is loose enough and contains its filaments and/or yarns in such a density and layer thickness as to let mating antislip protrusions to somewhat penetrate into the fibrous structure. Its suitable strength should be enough to exert, with its loose filament- and/or yarn sections, a force in the shearing direction on the mating antislip protrusions creating a mechanical bond of a suitable strength, a multiplicity of such individual mechanical bonds providing a suitable nonslip bond between the skidproofed surface-part and the roughened surface-part. The bond being suitable means it is a positive bond but it is not necessarily an extremely strong bond, also with respect to a suitable wear rate of the sack, see later below. The skidproofing material can, for example, be a nonwoven (e.g., spunbonded, meltblown, airlaid, spunlaid, combined etc.) fabric with free filament sections available for catching, or it can be a woven or knitted or other fabric whose structure or whose yarns' structure provides free sections of filaments and/or yarns for a hooking. The free filament and/or yarn sections should have both ends suitably anchored, such free filament or yarn sections often also called loops in the art. Further, the skidproofing material can for example be constituted by discrete fibrous units each individually fixed to the second wall each fibrous unit or at least a totality thereof providing a suitable fibrous structure. Such fibrous units could be for example fibrous loops or groups of loops randomly scattered or sprayed onto and adhered or welded to the second wall. The antislip protrusions project from the first wall of the sack. The protrusion can for example be unitary with the first wall (or with a layer subsequently united with the first wall), for example formed with a mould for example with respective cavities for each protrusion, or the protrusions can be formed from the first wall material in any other suitable way, for example by embossing or rubbing etc. in either cold and/or hot state. Further, the protrusions can be made with getting and fixing separate roughening units to the first wall in a random and/or regular arrangement. Each such roughening unit can provide for a single protrusion or for a plurality of protrusions. The roughening units can be made for example from a melt (e.g. with moulding) and/or with size reduction from a solid body etc. The roughening units and/or the protrusions can have regular and/or random shapes and arrangement. It is practicable for example to provide, and get and fix roughening particles to the first wall to produce the antislip protrusions. Each protrusion can include one or more such roughening particles with a suitable fixation. The provided roughening particles are for example granules of a polymer powder. The fixation can be for example an adhesion with an (e.g., pressure sensitive, crosslinked, or hot melt etc.) adhesive medium or a fused and/or welded fixation. The antislip protrusion can be hollow or solid, depending for example on a stiffness required. The protrusions can have regular and/or random shapes and their geometric features with respect to the skidproofing material should be suitable for the purpose, which in practice means for example that they are small enough to find room in free voids of the fibrous structure of the skidproofing material and big enough to effectively hook with its filaments and/or yarns. Also, the antislip protrusions have a suitable closeness with respect to the skidproofing material which in practice means for example that protrusions are far enough, in the surface, from each other to let the filaments and/or yarns in between the protrusions and close enough to each other to provide a sufficient number of individual mechanical bonds (per surface unit area) for the desired application.

The wear rate should be equal to or lower than 0.35 which expresses that such a sack should be selected for the purpose of packing plate-frozen fish blocks as can stand a slide, occurring in a special manner between its roughened and skidproofed surface-parts, without a too great loss of its antislip capabilities. The wear rate, generated with testing suitably selected specimens of the sack, is an extrinsic characteristic of the sack, determined by the wear-rate test. The wear rate is only revealed when the sack is, in the test, exposed to interaction with specifically chosen outside conditions such as sliding the roughened and skidproofed surface-parts with a particular displacement and at an unusually low temperature and under an unusually high pressure. None of these factors are part of the background art, especially not in such combination. None of these factors are selected arbitrarily but they are based on recognition about the special new combination meant by packing fish blocks plate-frozen at sea into antislip plastic sacks. The wear-rate test is meant to be performed with preventing white frost or ice from forming on the specimens at such an extent as could influence an outcome of the test, which can be provided, for example, with keeping air humidity at low levels. In the wear-rate test things known from the ISO 8295 standard are applied, though with special, different selection of certain parameters, as follows. The sled has an unusually small length of only 20 mm, measured in the direction in which the sled will slide. The sled's flat surface width can preferably be selected to be at least 20 mm, preferably 20 mm. It is, however, also possible to select a greater flat surface width, for example corresponding to one-fifth, or one-fourth, or one-third, or a half of a width of the skidproofed surface-part, or it could even correspond to the width of the skidproofed surface-part, for example in order of facilitating a selection of the specimens in a similar size. The wear rate test includes suitably selecting a specimen of the skidproofed second wall with the skidproofed surface-part and suitably selecting a specimen of the roughened surface-part. The particular way the specimens are selected can influence the resulting wear rate value if qualities of the roughened surface-part and/or of the skidproofed surface-part are essentially inhomogeneous along the surface. According to our definition, however, if it is possible to suitably select, in the sack, such specimens as result in a wear rate value between 0 and 0.35 then the sack is suitable to pass the wear rate test with the result of the wear rate being between 0 and 0.35. In practical use it is possible and preferable that such an essential inhomogeneity does not exist in the sack, and preferably a representative, or average, wear rate value is between 0 and 0.35. Nevertheless, in case of such an essential inhomogeneity, the skilled person, looking for a suitable selection of the specimens, can, for example, select a plurality of specimen-pairs from a given individual sack and perform the wear-rate test with all of those specimen-pairs to find the specimen-pair(s) possibly resulting a suitable wear rate value. It is also possible to provide a plurality of representative sacks in order to better explore a nature of the mentioned possible inhomogeneities, with regard to a destructive nature of the wear rate test. Analogously, if the result shows an essential dependency on a relative orientation of the specimens during the sliding then the test can include suitably orienting the specimen of the roughened surface-part prior to the bringing into the face-to-face relationship. A preferable product, however, is essentially isotropic in this regard. In the sled assembly, the skidproofed surface-part is available for gripping with and sliding on another, roughened, surface-part. The specimen with the skidproofed surface-part, e.g., a piece cut out of the sack's second wall, should be fixed to the sled firmly enough so it can withstand the unusually high shearing force during the slide. It is good to bend up and firmly fix the specimen to the sled body in front of as well as behind the flat surface. The sliding must be performed at a temperature of −20° C. for which the test devices should preferably be kept that cold prior to the wearing operation, and also sufficient time should be provided for the specimens to cool down. The roughened surface-part specimen, e.g., a piece cut out of the first sack wall, is greater in size than the mating area of the other specimen, and should also be kept suitably strongly against the unusually strong frictional forces. The force, exerted by the sled assembly to the roughened surface-part specimen in a direction perpendicular to the abutting surfaces, should maintain an effective pressure of 11557 Pa between the abutting surfaces. The sled assembly is placed on the roughened surface-part specimen defining (being face-to-face with) the first area thereof. The slide length is 40 mm's. During the slide the sled assembly enters, sweeps and leaves the second area and finally stops in a configuration defining (being face-to-face with) the third area of the roughened surface-part specimen. It means that the first, second and third areas are contiguous and consecutive in the direction of the slide and each area is 20 mm's long in that direction. (It would not influence the test result if the third area was not roughened, as long as it would not cause any other harmful discrepancies in the test. That could be a choice if the geometry of the roughened surface-part(s) make it difficult to take a specimen large enough.) At planning the slide, one should select the first, second and third areas, and prior to the slide the second area should be evaluated in order of recording the first protrusion number. In order thereof, the second area should be looked at (or preferably: photographed or digitally scanned) from above the antislip protrusions, in a top plan view, i.e., from a direction perpendicular to the sack wall. In the top plan view each antislip protrusion has a respective size. In this sense, the top-plan-view size of an antislip protrusion is defined as its greatest extent in the top plan view and could be expressed in micrometres. The limit size is defined as the half of the average of the respective size values of each antislip protrusion of the second area, measured before the sliding. The first protrusion number is a parameter of the second area prior to the slide, and is defined as the number of the antislip protrusions available in the second area before the sliding and having a top-plan-view size greater than the limit size. That can be measured, for example, from the photograph or digital image taken of the second area prior to the slide. Analogously, the second protrusion number can be measured, for example, from a photograph or digital image taken of the same second area after the slide. In measuring the second protrusion number, the limit size parameter defined prior to the slide should be used. The wear rate actually expresses a relative decreasing in the number of the antislip protrusions caused by one slide. The smallest antislip protrusions are disregarded in this calculation because they are not expected to practically take part in a mechanical bond between the packages in the presence of precipitated white frost.

The advantage of the package invention is that the selected suitably low wear rate provides that the package can participate in a stacking-and-re-stacking operation, possibly involving a sliding of one package on the other, still retaining a suitable proportion of its original antislip shear-strength. That can be provided for by retaining a suitable proportion of its originally available mechanical bonds, due to retaining a suitable proportion of its originally available antislip protrusions.

The skilled person, aiming to decrease the wear rate when making a sack, can follow any one or more of the following possibilities, for example on a trial-and-error basis. Increasing the flexibility of the sack wall (or at least of a top layer of the sack wall) carrying the antislip protrusions can decrease the wear rate because the antislip protrusions can bend more easily, and reversibly, together with the sack wall portion around their feet, to the side when shearing stress arises. Further, selecting a polymer in the antislip protrusions with a suitably low stiffness can decrease the wear rate because the antislip protrusions can get somewhat deformed (rather than break off) when shearing stress is exerted on them by the loops of the skidproofing material. A protrusion thus deformed may remain effective in providing a bond in a different (but also shearing) direction later. Decreasing the height and width of the undercuts of the antislip protrusions means for example providing spherical particles and embedding (e.g., through welding or adhering) them to a greater extent into the wall surface. That would mean selecting, instead of protrusions looking like tiny water droplets sitting on a non-wettable surface, protrusions looking like a heavy ball floating on water. That would provide a greater footprint surface area which means a stronger fixation against breaking off. Also, that would mean a smaller undercut-height, above the sack wall, which can result in lower turning torque exerted on the protrusion by a loop of the skidproofing material. The above measures go against the technical prejudice and indeed act to decrease the maximum shear strength of the bond but the skilled person can find a reasonable balance between shear strength and wear rate for example by trial-and-error.

It is preferable if the wearing operation includes 2, more preferably 3, even more preferably 4 successively repeated slides of the sled assembly before the recording of the second protrusion number. It has the advantage that such a package can be re-stacked manually more times, keeping much of its shear strength.

It is preferable if the resulting wear rate is equal to or lower than 0.3, more preferably 0.25, more preferably 0.2, more preferably 0.17, even more preferably 0.15. It has the advantage that such a package can be re-stacked manually more times, keeping much of its shear strength.

Though a too emphasised undercut of the antislip protrusions may not be beneficial in the sack, it is preferable if in at least some antislip protrusions (more preferably in at least one twentieth of the antislip protrusions, more preferably in at least one tenth of the antislip protrusions, more preferably in at least a quarter of the antislip protrusions, more preferably in at least a majority of the antislip protrusions) the antislip protrusion has a hidden surface portion being a portion of an outer surface of the antislip protrusion which the antislip protrusion covers from a viewer in a top plan view of the first wall taken from above the antislip protrusions. Namely, its covered surface portions can serve for the free filaments and/or yarns as hooking points. If these covered surface portions look towards the first wall with only a slight angle or are nearly perpendicular to the first wall than the hooking will be sufficiently gentle, possibly making it possible for the hooked filaments and/or yarns to get released by the protrusion bending a little to the side. As used herein, a “majority” of the antislip protrusions means a number of the antislip protrusions that is greater than half of a total number of the antislip protrusions. A “quarter” (or “one tenth”, or “one twentieth”, respectively) “of the antislip protrusions” means a number of the antislip protrusions that is one fourth (or one tenth, or one twentieth, respectively) of a total number of the antislip protrusions.

It is preferable if at least some of the antislip protrusions (more preferably at least one twentieth of the antislip protrusions, more preferably at least one tenth of the antislip protrusions, more preferably at least a quarter of the antislip protrusions, more preferably at least a majority of the antislip protrusions) break the filament or yarn at a suitable load of the mechanical bond formed between the filament or yarn and the antislip protrusion. It substantially means that the antislip protrusion is stronger than the filament or yarn, therefore it is the filament or yarn, but not the antislip protrusion, that breaks at an overload of the mechanical bond formed between the filament or yarn and the antislip protrusion. For that purpose, the antislip protrusion should have suitable fixation with the first wall and suitable stiffness with respect to the skidproofing material. That can be provided by strengthening the protrusions against breaking off and/or by weakening the filaments and/or yarns, all in order that if something must break, to release the hooking, then it should be the filaments or yarns that break and the antislip protrusion should be prevented from breaking off. The advantage thereof is that though it decreases the number of available free filament- and/or yarn sections, it does not decrease the number of available protrusions, therefore much of the shear strength of the system can be retained especially if the skidproofing material is otherwise rich in free filament- and/or yarn sections. Using relatively few antislip protrusions per cm² could help in keeping low a number of filaments or yarns (per cm²) broken in one sliding operation which could help retain the original shear strength even more. The skilled person could find a good balance between shear strength and wear resistance by trial-and-error in selecting protrusion number per cm². It is, in combination, even more preferable if the first wall includes a woven fabric. Namely, the fabric, woven from flat polymer tapes, is known to be more rigid, less flexible than a plastic film (e.g., blown film) of equivalent thickness. Therefore, it will not bend easily under the protrusions therefore the protrusions breaking the filaments or yarns is a preferable way of saving the protrusions from deforming too much or even breaking off, which is an advantage. It is, in combination, even more preferable if, at least in one or more portions of the first wall (preferably in an entirety thereof), the first wall is free of a pressure sensitive adhesive layer between the woven fabric and the antislip protrusions. Namely, if the wall is layered in a way in which the antislip protrusions project from an outermost plastic layer thereof which outermost plastic layer is fixed directly or indirectly to the woven fabric with a fixation including a pressure sensitive adhesive layer than that pressure sensitive adhesive layer can provide a local flexibility to the outermost plastic layer carrying the protrusions letting the latter bend under a load but if the wall is free from such pressure sensitive adhesive layer then the protrusions will not be able to bend easily which gives a special significance to this feature.

It is preferable if the antislip protrusions include polypropylene and/or the first wall includes polypropylene and/or the skidproofing material includes polypropylene (more preferably the antislip protrusions and the first wall and the skidproofing material include polypropylene). The term “include” means they are fully or partly of polypropylene, the term “polypropylene” also including copolymers of polypropylene and with or without additives and/or fillers. The significance of this feature originates from the glass transition temperature of polypropylene typically being between 18° C. and −20° C. as we mentioned in the recognition section.

It is preferable if a static friction between the roughened surface-part and the skidproofed surface-part is suitably high to resist sliding at a temperature of −20° C. in an inclined-plane-type static-friction test of 50 degrees angle according to the TAPPI T 815 standard, more preferably 55 degrees, even more preferably 60 degrees. This is meant to be tested using surface-part specimens free from sliding wear. This test is meant to be performed with preventing white frost from forming on the specimens, which can be provided, for example, with keeping air humidity at low levels. Its advantage is that such packages can withstand the up-to −45°-angle tilting of the vessel.

It is preferable if the fish is unfilleted, more preferably headed-and-gutted fish. That, namely, provides actual block geometry in particular correlation with our model, as mentioned above.

Below we provide method inventions and their preferred embodiments for producing and using the invention packages. The meaning of the terms used, as well as provided advantages correspond to and are analogous with those discussed with regard to the package invention above.

The essence of a method invention is a method for producing a stackable package, according to any embodiments of the above-described invention package, including
providing a packaging sack for packing a block of plate-frozen fish for producing a stackable package,
the method being new in that
the provided sack is a plastic sack having a second outer surface, on which the package can be laid on a stack, and an opposing first outer surface, and
   at least a part, the roughened surface-part, of the first outer surface comprising antislip protrusions projecting from a first wall of the sack, and
   at least a part, the skidproofed surface-part, of the second outer surface comprising a skidproofing material, of a loose, fibrous structure, fixed, at least against slipping, to a second wall of the sack, which skidproofing material is capable of a nonslip bond with the antislip protrusions due to the antislip protrusions having suitable closeness and geometric features with respect to the skidproofing material and due to the skidproofing material including filaments or yarns in such a density and layer thickness at which a mechanical bond can be formed between the filaments or yarns and the antislip protrusions,
   the sack being suitable to pass a wear rate test with a result of a wear rate of between 0 and 0.35,
   the wear rate test comprising the steps of
      providing a sled,
      the sled having a rectangular flat surface on which the sled is suitable to slide in a sliding direction, the flat surface having a flat surface length of 20 mm parallel with the sliding direction, and a flat surface width of at least 20 mm in a direction perpendicular to the sliding direction,
      providing a sled assembly by covering the sled flat surface in a suitably selected specimen of the sack second wall with the skidproofed surface-part providing a sliding surface of the sled assembly,
      in a wearing operation bringing the sliding surface into a face-to-face relationship with a first area of a suitably selected specimen of the roughened surface-part and then maintaining a temperature of −20° C. in the sliding surface and the roughened surface-part specimen and a normal compression of 11557 Pa between them while sliding 40 mm's in the sliding direction the sled assembly on the roughened surface-part specimen for bringing the sliding surface into a face-to-face relationship with a third area of the roughened surface-part specimen,
      in the roughened surface-part specimen the first area and the third area defining a second area therebetween, having antislip protrusions,
      recording a first protrusion number equalling a number of the antislip protrusions available in the second area before the sliding and having a top-plan-view size greater than a limit size, the limit size being a half of an average of the respective top-plan-view sizes of each antislip protrusion available in the second area before the sliding,
      recording a second protrusion number equalling the number of the antislip protrusions available in the second area after the sliding and having a top-plan-view size greater than the limit size,
      defining the resulting wear rate equalling a difference, between the first protrusion number and the second protrusion number, divided by the first protrusion number.

Providing a packaging sack for packing a block also includes providing a packaging sack for packing a plurality of blocks in a single sack.

It is preferable if the method further includes providing a block of plate-frozen fish and packing the block into the sack for providing a stackable package. Note that this includes that either one block or a plurality of blocks can be packed into the sack.

It is preferable if the provided block contains unfilleted, more preferably headed-and-gutted fish.

It is preferable if the method further includes closing the package with making a seam across the sack with welding, providing venting paths for air through the seam. This is advantageous because it lets entrapped air get out of the package on stacking in order that the packages have a firm non-slip abutting on each other.

The essence of a method invention is a method for using stackable packages including
providing a first package and a second package and a stacking base,
forming a stack from the packages including laying the first package on the stacking base and placing the second package upon the first package,
the method being new in that
each of the first and second packages is provided according to any embodiment of the package invention above, and
the forming of the stack includes, for providing an antislip grip between the packages, one or both of
   laying the skidproofed surface-part of the second package upon the roughened surface-part of the first package and
   laying the roughened surface-part of the second package upon the skidproofed surface-part of the first package.

The stacking base can be any suitable surface onto which a package can be laid, e.g., it can be a floor, or it can be a pallet, or it can be a flat top surface of a package constituting a top of a stack etc. Placing the second package upon the first package may, for example, mean that the second package is propped up only by the first package but it is also possible that the second package somewhat hangs out of the first package in a top view. The centre of mass of the second package can be positioned within the first package, in the top view, or beside it. Laying the skidproofed surface-part of the second package upon the roughened surface-part of the first package can, for example, mean that one or more such portions, of the skidproofed surface-part of the second package, are provided as are left out of a contact with the roughened surface-part of the first package, and, analogously, one or more such portions, of the roughened surface-part of the first package, can be provided as are left out of a contact with the skidproofed surface-part of the second package. Analogously, laying the roughened surface-part of the second package upon the skidproofed surface-part of the first package can, for example, mean that one or more such portions, of the roughened surface-part of the second package, are provided as are left out of a contact with the skidproofed surface-part of the first package, and, analogously, one or more such portions, of the skidproofed surface-part of the first package, can be provided as are left out of a contact with the roughened surface-part of the second package.

It is preferable if in the method, the provided antislip grip is suitable to keep the second package from sliding on the first package on tilting the stacking base into a slanting orientation closing with the horizontal an angle of 35 degrees, more preferably 40 degrees, more preferably 45 degrees, more preferably 50 degrees, more preferably 55 degrees, more preferably 60 degrees. Any missing parameters of this tilting are taught in the TAPPI T 815 standard. This antislip grip can be achieved through selecting suitably large sizes of the contacted roughened surface-part and skidproof surface-part, respectively. The best performance is provided when in each package the whole abutting package-surface is exploited for the purpose. This feature is particularly advantageous when the packages are stacked in a vessel potentially exposed to waves of sea. Therefore, it is preferable, if, in combination, the stack is formed aboard a vessel.

It is preferable if the forming of the stack includes laying the skidproofed surface-part of the second package upon the roughened surface-part of the first package and the method further includes, for a dismantling of the formed stack, lifting a first edge of the second package simultaneously letting an opposing second edge thereof abut on the first package thereby rotating the second package, from a first orientation of the second package into a second orientation of the second package, with an angle of between 1 degree and 50 degrees, and then keeping the second package essentially in its second orientation while sliding the second package on the first package. This method provides the advantages discussed in detail in the recognition section of this document.

### BRIEF DESCRIPTION OF THE DRAWINGS

FIG. 1. is a top view of a package.

FIG. 2. is a cross section of the package of FIG. 1.

FIG. 3. is a perspective view of the sack of the package of FIG. 1.

FIG. 4. is a perspective view of the sack of the package of FIG. 1.

FIG. 5. is a side elevation of an antislip protrusion.

FIG. 6. is a perspective view of a sled.

FIG. 7. is a perspective view of a sled assembly.

FIG. 8. is a section of the sled assembly.

FIG. 9. is a perspective view of a roughened surface-part specimen.

FIG. 10. is a perspective view of the roughened surface-part specimen with the sled assembly.

FIG. 11. is a perspective view of the roughened surface-part specimen with the sled assembly.

FIG. 12. is a top plan view of an antislip protrusion.

FIG. 13. is a top plan view photograph of a roughened surface-part specimen.

FIG. 14. is a top plan view photograph of a roughened surface-part specimen.

FIG. 15. is a top plan view photograph of a roughened surface-part specimen.

FIG. 16. is a top plan view photograph of a roughened surface-part specimen.

FIG. 17. is a top plan view photograph of a roughened surface-part specimen.

FIG. 18. is a top plan view photograph of a roughened surface-part specimen.

FIG. 19. is a top plan view photograph of a skidproofing material.

FIG. 20. is a part of FIG. 19. in a stronger magnification.

FIG. 21. is a side view of a stack.

FIG. 22. is a side view of a stack.

FIG. 23. is a top view of a package.

### DETAILED DESCRIPTION

### Examples

### Example 1: A Comparative Example (Nonwoven Fabric)

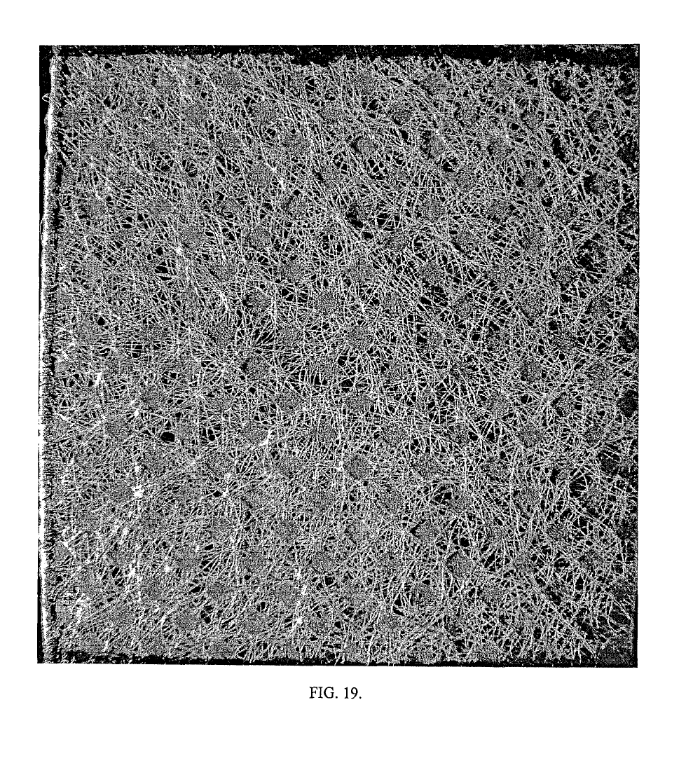

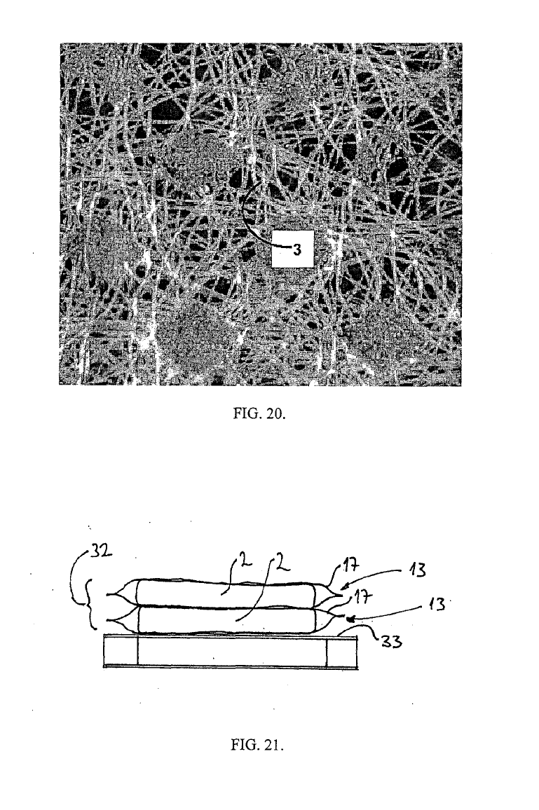

See FIGS. 19-20. We measured and found at −15° C. temperature that a polypropylene spunbonded nonwoven fabric of a surface weight of 17 g/m² had a 12% strain at breaking. At room temperature, the 12% strain was insufficient to break the same nonwoven. On the other hand, the stress at the 12% strain was 80.7% greater at −15° C. temperature than at room temperature. That illustrates a significance of temperature as a parameter in the behaviour of the invention antislip system.

### Example 2: A Comparative Example (Package 13)

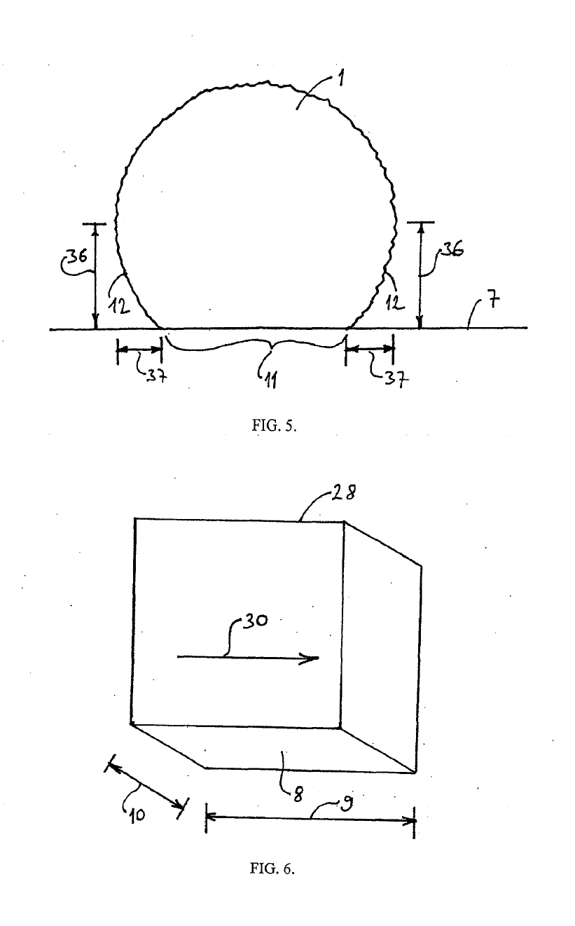

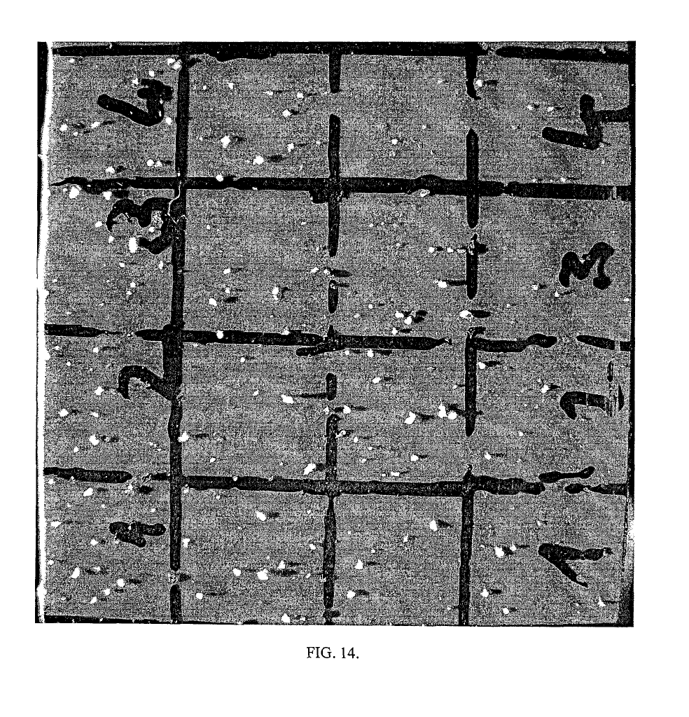

The comparative example package 13 could comprise a 25-kg sea-frozen unfilleted, headed-and-gutted fish block 2, made with a vertical plate freezer, the approximate dimensions of the block 2 being 10 cm×53 cm×53 cm. The packaging sack 17 is a plastic film sack 17 whose both first wall 17 and second wall 24 comprise the film which we prepared as follows. We made a 100-micrometre-thick polyethylene film, with film blowing. During the blowing we sprayed particles of a polyethylene powder onto the emerging melted film bubble, in a way essentially corresponding to Example 1 of U.S. Pat. No. 6,444,080 B1. During the cooling the particles were given time to weld to the film. Following the teaching of the background art we used a reactor powder of an expressly high-density polyethylene, of a density of 961 kg/m³, for a great abrasion resistance thereof. We screened the powder to fractions and used a fraction of 200 to 315 micrometres. We set the welding time and -energy to a point at which we were able to provide great undercut heights 36 and undercut widths 37 (see FIG. 5) in the antislip protrusions 1 and a typical antislip protrusion 1 shape similar to a water droplet sitting on an almost non-wettable surface. We applied about 80 to 100 roughening particles per cm². In a side view of the antislip protrusions 1 we can observe many antislip protrusions 1 whose rightmost and/or leftmost points are at a free distance of about 100 to 130 micrometres from the outer surface of the film, just corresponding to the teaching of the background art. Naturally, the antislip protrusions 1 typically have hidden surface portions 12 because they cover a portion of their own outer surfaces from a viewer in a top plan view of the first wall 7 taken from above the antislip protrusions 1. We adhered a skidproofing material 27 (see FIGS. 19-20) to the second wall 24 with a circular fibrous spray pattern of hot melt adhesive against peeling and the fixation, against slipping, between the skidproofing material 27 and the second wall 24 was provided by the nonslip bond arising between the antislip protrusions 1 of the second wall 24 and the skidproofing material 27. As skidproofing material 27 we applied the polypropylene spunbonded nonwoven fabric of a surface weight of 17 g/m² mentioned in Example 1. We measured the filament thickness of the nonwoven to be between 25 and 30 micrometres. We took specimens from the sack's 17 first 7 and second walls 24. They passed, at a temperature of −20° C., the inclined-plane-type static-friction test of 60 degrees' angle without sliding. That proves that the static coefficient of friction is some value greater than 1.73 (equalling tan 60°) which is extremely good in comparison with ordinary packaging materials. (An ordinary packaging material, such as kraft paper, is usually never able to reach a standard static coefficient of friction as high as 1.0, while an ordinary polyethylene film is usually never able to reach 0.5). We also measured the static coefficient of friction according to ISO 8295, and we found it was about 15.0 which is extremely high. We performed the wear-rate test with a single slide of the sled assembly 29, and found the wear rate of the sack 17 to be about 0.41. We theorise that if we had used a polyester or even polyamide nonwoven for the skidproofing material 27, as taught in the background art, and possibly even filaments or yarns 3 thicker than 25 . . . 30 micrometres then the wear rate would have been even greater. FIG. 13 is a top-plan-view photograph of a second area 21 of the film of a size of 20×20 mm before the sliding. FIG. 14 is a top-plan-view photograph of the same second area 21 of a size of 20×20 mm after the sliding. FIG. 19 is a top-plan-view photograph of an area of a size of 20×20 mm of the skidproofing material 27 in a new condition. FIG. 20 is a magnified portion of FIG. 19. Our conclusion is that if the respective antislip surfaces are homogeneously of the measured qualities (which is a practical assumption) than the sack 17 is not good for our objective of packing plate-frozen fish blocks 2 despite its high initial shear strength.

### Example 3: Package 13

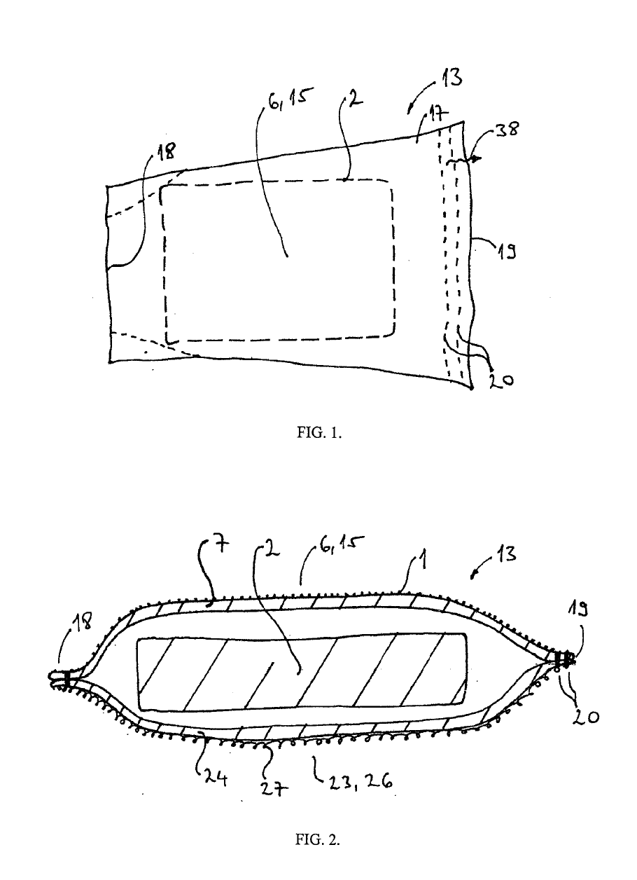

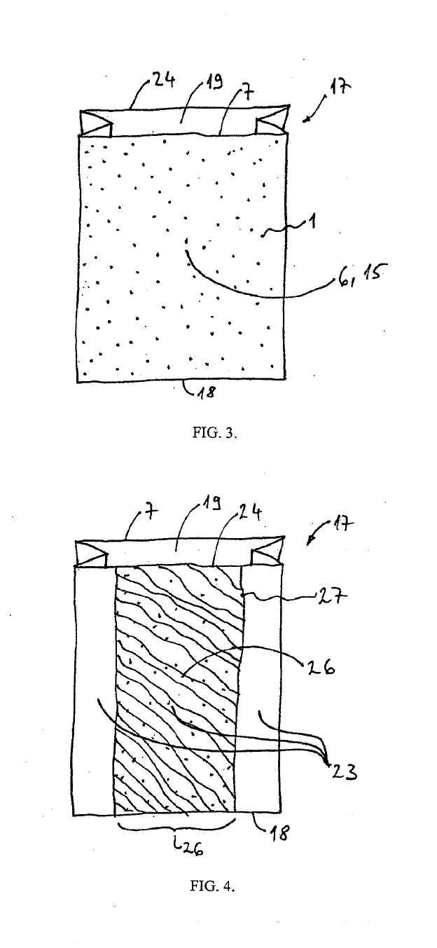

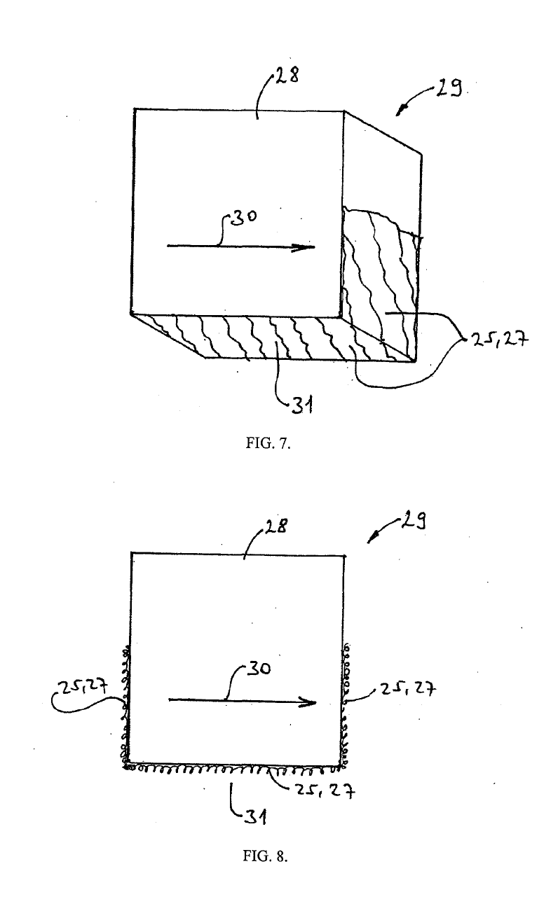

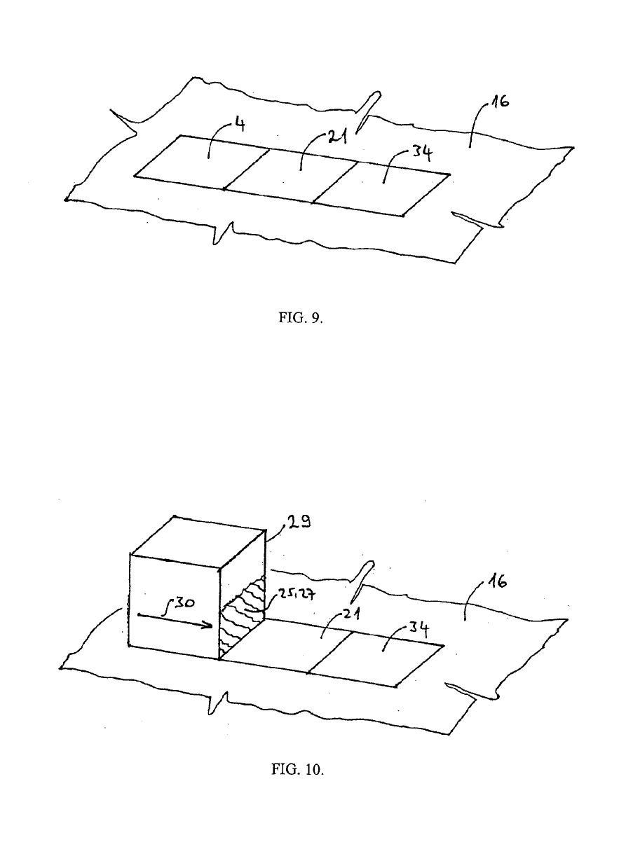

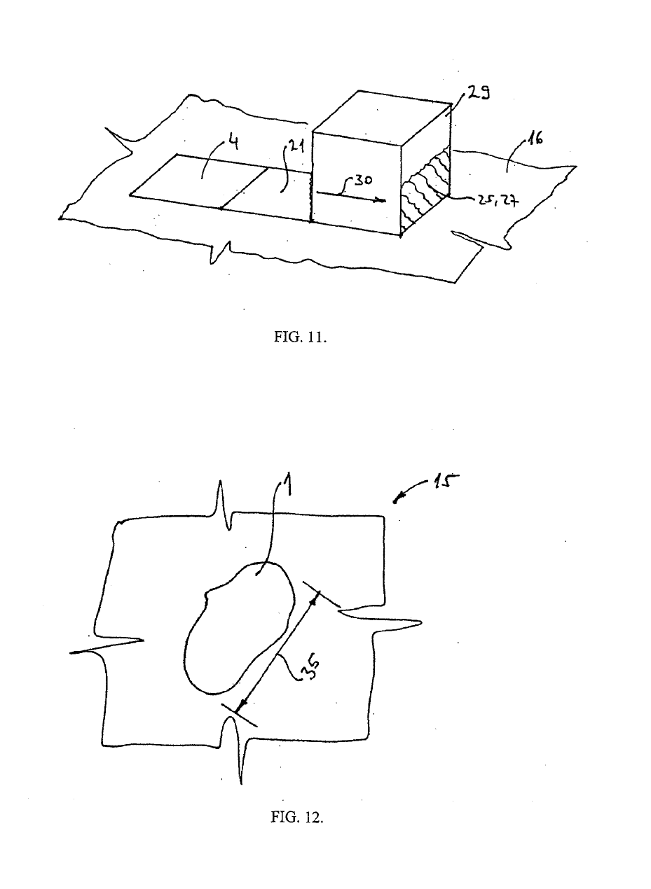

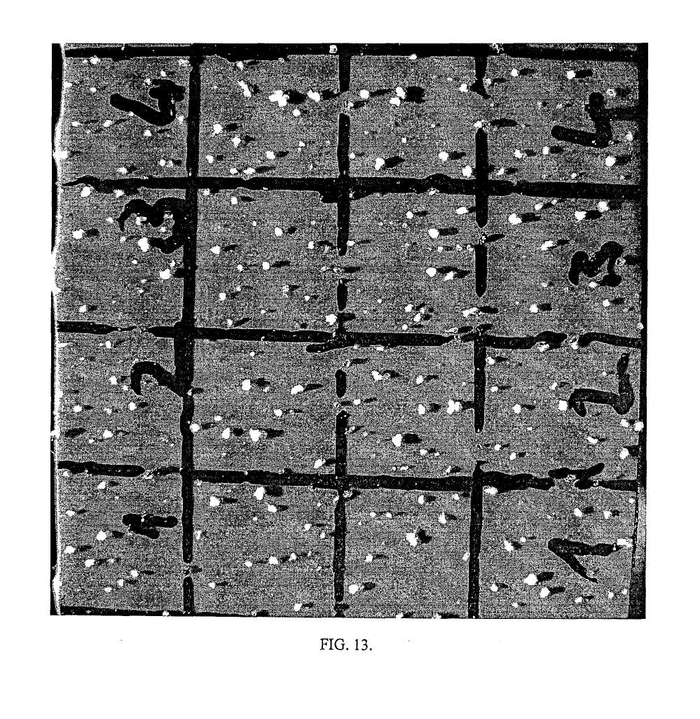

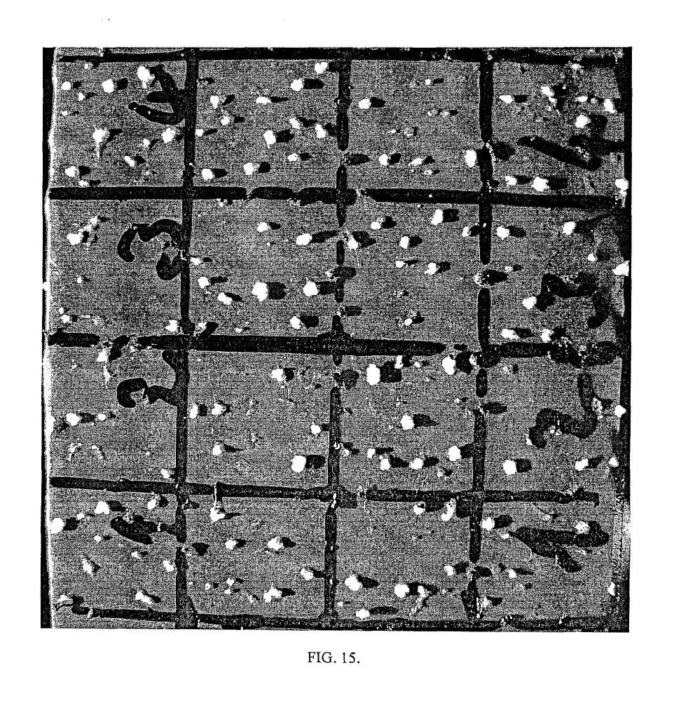

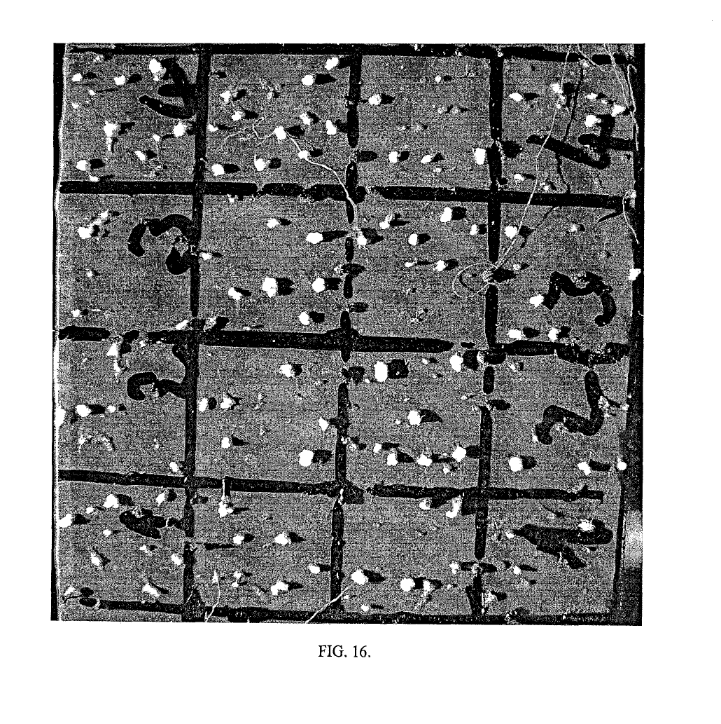

See the FIGS. 1-12. The example package 13 could comprise a 25-kg sea-frozen unfilleted, headed-and-gutted fish block 2, made with a vertical plate freezer, the approximate dimensions of the block 2 being 10 cm×53 cm×53 cm. The packaging sack 17 is a side-gusseted plastic film sack 17 of a width of 560 mm+2×60 mm gussets, and a height of 810 mm. Both the first wall 7 and second wall 24 of the sack 17 comprise the film which we prepared as follows. We made a 100-micrometre thick polyethylene film, with film blowing. This example differs from that of Example 2 in that a different roughening was applied on the sack 17 film. For roughening the film, we used a polyethylene powder (made by grinding from pellets) of a density of 944 kg/m³, which is lower than in Example 2, for a better weldability thereof. We used a size-fraction of 160 to about 300 micrometres. We applied about 40 roughening particles per cm². We provided a welding energy somewhat greater than that in Example 2 when we welded the powder to the film bubble. The result is that the antislip protrusions 1 do not have quite such great undercut heights 36 and undercut widths 37 as in Example 2, nor quite such regular spherical shapes but appear to have somewhat greater footprint surface areas 11 (i.e., contact fixation areas with the film) in a side view. Nevertheless, in many antislip protrusions 1 the antislip protrusion 1 has a hidden surface portion 12 as it covers a portion of its own outer surface from a viewer in a top plan view of the first wall 7 taken from above the antislip protrusions 1. We roughened the whole first wall 7 from outside (i.e., the first outer surface 6), therefore the whole first outer surface 6 is a roughened surface part 15. We roughened at least that part of the opposing, second wall 24, from outside (i.e., of the second outer surface 23), which is covered by the skidproofing material 27. We adhered a skidproofing material 27 of a width of 50 cm to the middle of the second outer surface 23 with a circular thin fibrous spray pattern of hot melt adhesive against peeling, and the fixation, against slipping, between the skidproofing material 27 and the second wall 24 is provided by the nonslip bond arising between the antislip protrusions 1 of the second wall 24 and the skidproofing material 27. The skidproofing material 27 is continuous from the sack bottom 18 to the sack mouth 19. That provides the skidproofed surface-part 26. As skidproofing material 27 we applied the polypropylene spunbonded nonwoven fabric of a surface weight of 17 g/m² mentioned in Example 1. We measured the filament 3 thickness of the nonwoven to be between 25 and 30 micrometres. (The same skidproofing material 27 was applied, fixed the same way as in Example 2.) We took a roughened surface-part specimen 16, from the first wall 7, and a second wall specimen 25, from the skidproofed surface-part 26. They passed, at a temperature of −20° C., the inclined-plane-type static-friction test of 60 degrees' angle without sliding. We provided a steel sled 28 with a flat surface 8 of a flat surface length 9 of 20 mm and a flat surface width 10 of 20 mm. To make the sled assembly 29, we adhered the second wall specimen 25 to the flat surface 8 and also bent it up on the sides of the sled 28 in front of and behind the flat surface 8 (with regard to the sliding direction 30). We turned the skidproofed surface-part 26 of the second wall specimen 25 to look outside and thereby to provide a sliding surface 31 of the sled assembly 29. To start the wearing operation, we put down the sliding surface 31 of the sled assembly 29 onto the roughened surface-part specimen 16, thereby defining the first area 4 of the roughened surface-part specimen 16 (just being in face-to-face relationship with the put-down sliding surface 31). This phase is illustrated in FIG. 10. We planned the future sliding motion of the sled assembly 29 (of 40 mm's in the sliding direction 30 thereof) and found and signed the second 21 and third 34 consecutive areas of the roughened surface-part specimen 16, each 20 mm long and 20 mm wide with regard to the sliding direction 30. See FIG. 9. We examined, prior to the slide, the antislip protrusions 1 of the second area 21 (which is adjacent to the first area 4 mentioned above). We photographed the second area 21 from above the antislip protrusions 1 and could see the antislip protrusions 1 in top plan view. For each antislip protrusion 1 we stated its greatest extent in this view, that being the top-plan-view size 35 of the antislip protrusion 1. We could calculate the limit size being the half of the average of all of the respective antislip protrusion 1 top-plan-view sizes 35 in the second area 21. We found the first protrusion number (defined as the number of the antislip protrusions 1 available in the second area 21 before the sliding and having a top-plan-view size 35 greater than a limit size) to be 159. Then we put the whole test assembly into a freezer of a temperature of −20° C. for a time long enough to provide such temperature in the specimens. We maintained a normal (i.e., perpendicularly-directed) pressing to provide the normal compression of 11557 Pa under the sled assembly 29 sliding surface 31 and performed one slide thereof, in the sliding direction 30, with a speed of 100 mm/minute and with a total displacement of 40 mm's. The configuration immediately after the slide is illustrated in FIG. 11. We then removed the sled assembly 29 from the third area 34 of the roughened surface-part specimen 16 with a perpendicular lifting-off. We photographed the second area 21 again, and found the second protrusion number (equalling the number of the antislip protrusions 1 available in the second area 21 after the sliding and having a top-plan-view size 35 greater than the original limit size) to be 151. Thus, we performed the wear-rate test with a single slide of the sled assembly 29, and found the wear rate of the sack 17 to be 0.05 (equalling (159−151)/159). We found broken fragments of filaments 3 from the nonwoven. With further wear-rate tests we found the respective surfaces to be essentially homogeneous and essentially insensitive to a relative orientation in the regard of the wear rate, therefore this wear rate value is essentially representative of the product. FIG. 15 is a top-plan-view photograph of a second area 21 of the film of a size of 20×20 mm before the sliding. FIG. 16 is a top-plan-view photograph of the same second area 21 of a size of 20×20 mm after the sliding. FIG. 19 is a top-plan-view photograph of an area of a size of 20×20 mm of the skidproofing material 27 in a new condition. FIG. 20 is a magnified portion of FIG. 19. We theorise that the better quality and greater surface of the welding, fixing the particles to the film, did not let them break off, but instead they possibly bent to the side and also, they surely broke at least some filaments 3 to release them. Our conclusion is that the sack 17 is very suitable for packing plate-frozen fish blocks 2.

### Example 4: Package 13

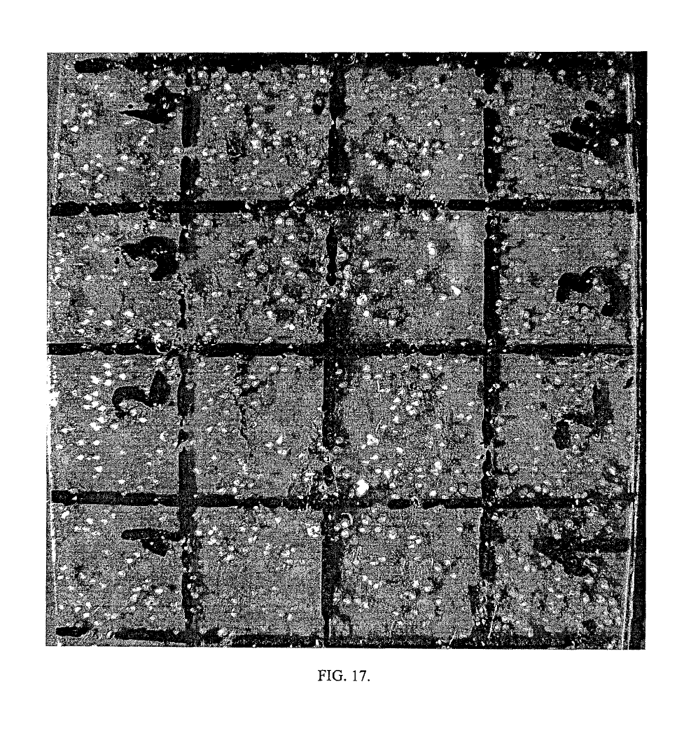

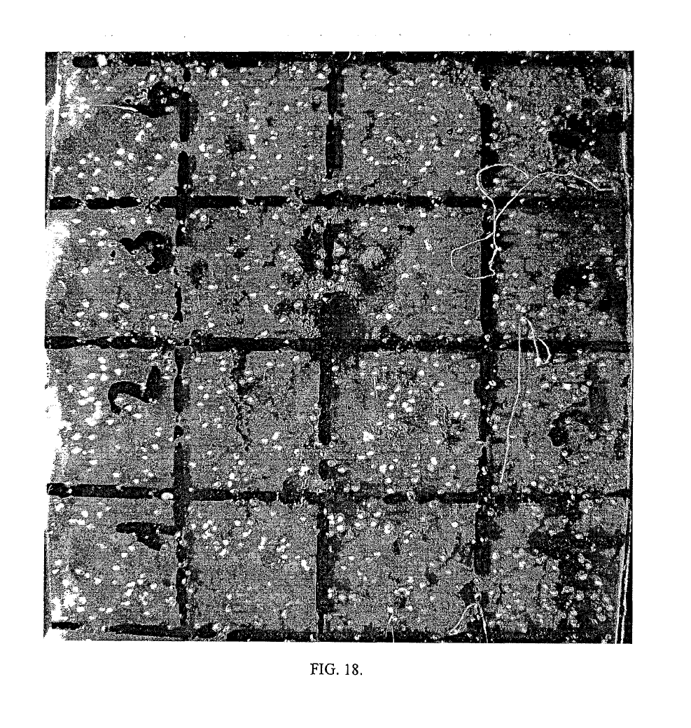

This example differs from that of Example 3 in that a different roughening was applied on the sack 17 film. We used a different film, namely a 150-micrometre-thick polyethylene film, corona treated once, having a treatment of at least 42 dyn/cm (measured with a 42-dyn test ink). For roughening the film, we used the same high density polyethylene reactor powder grade as in the Comparative Example 2, of the density of 961 kg/m³. We used a screened size-fraction of 125 to 180 micrometres for the roughening. We applied about 160 roughening particles per cm². We adhered the particles to the film. Namely, we applied a lacquer to the film surface and sprayed the powder particles into the tacky lacquer then crosslinked the lacquer with ultraviolet light irradiation. The particles were blown through a corona discharge treating station while they were sprayed onto the film in order to provide a good bond between the particles and the lacquer. We recorded the following manufacturing data. Lacquer type used: SunChemical IU 10050 screen-printing UV lacquer (Spanish make). Lacquer viscosity we measured to be 73 seconds at 20° C. with DIN cup 4 (much thicker than water). Lacquer quantity applied to the film (cured): 9.57 g/m², corresponding to 8.7 micrometres lacquer thickness (without powder in it). The result was that we got small, but many, antislip protrusions 1 not seeming to have very sharp or high undercuts. Nevertheless, in many antislip protrusions 1 the antislip protrusion 1 has a hidden surface portion 12 covered by the antislip protrusion 1 from a viewer in a top plan view of the first wall 7 taken from above the antislip protrusions 1. The same skidproofing material 27 was applied, fixed the same way as in Examples 2 and 3. We took specimens from the sack's first 7 and second 24 walls. They passed, at a temperature of −20° C., the inclined-plane-type static-friction test of 60 degrees' angle without sliding. We performed the wear-rate test with a single slide of the sled assembly 29, and found the wear rate of the sack 17 to be 0.02. We found broken fragments of filaments 3 from the nonwoven. FIG. 17 is a top-plan-view photograph of a second area 21 of the film of a size of 20×20 mm before the sliding. FIG. 18 is a top-plan-view photograph of the same second area 21 of a size of 20×20 mm after the sliding. FIG. 19 is a top-plan-view photograph of an area of a size of 20×20 mm of the skidproofing material 27 in a new condition. FIG. 20 is a magnified portion of FIG. 19. We theorise that the strong adhesive and a good wetting of the particles by the adhesive, fixing the particles to the film, did not let them break off, but instead they possibly bent to the side and also they surely broke at least some filaments 3 to release them. This system appears to be suitable to provide a wear rate lower than 0.15 even if the wearing operation includes 4 successively repeated slides before the recording of the second protrusion number. Further, we analysed the static-friction performance of this lacquer-fixed roughening with the same skidproofing material 27, at usual moderate pressures, and found the following. Using about 1 gramme of powder for roughening 1 m² of film, at 1150 Pa pressure the static coefficient of friction was measured to be 5.8, the dynamic coefficient of friction was measured to be 5.4. At 3440 Pa pressure the static coefficient of friction was measured 2.8, the dynamic coefficient of friction was measured to be 2.6. Our conclusion is that the sack 17 is very suitable for packing plate-frozen fish blocks 2.

### Example 5: Package 13

To provide the sack 17 of the package 13, the roughening described in Example 4 could be applied to a circularly woven polypropylene or polyethylene fabric sack 17 of a fabric weight of 60 g/m² to 80 g/m². The dimensions of the sack 17 can be the same as those of the sack 17 of Example 3. In one embodiment, the fabric could be uncoated. In another embodiment, the roughening could be applied to a coated surface of the fabric, the coating being polypropylene or polyethylene and made with extrusion coating. In such an embodiment, there is not any pressure sensitive adhesive layer between the fabric and the antislip protrusions 1. In yet another embodiment the roughening particles could have a welded fixation with a plastic layer which is fixed to the fabric by coating in a moulded condition.

### Example 6: Method for Producing a Package 13

See FIG. 1. In this Example method, the sack 17 of Example 5 is provided for packing the block 2 of plate-frozen fish of Example 3 for producing a stackable package 13. The block 2 is put into the sack 17. Thereafter the mouth 19 of the sack 17 is closed with two parallel cross welding seams 20. For the welding, a flat welding tool can be used whose sections, of about 6 mm's in length, are kept cold (e.g., with keeping a heating wire short-circuited in that section length with an aluminium plate insert contacted therewith). The cold sections are separated with respective hot sections of similar length, thereby a welding pattern, including a series of welded areas separated by non-welded areas, is created. The non-welded areas provide venting paths 38 for air through the seam 20.

### Example 7: Method for Using a Package 13

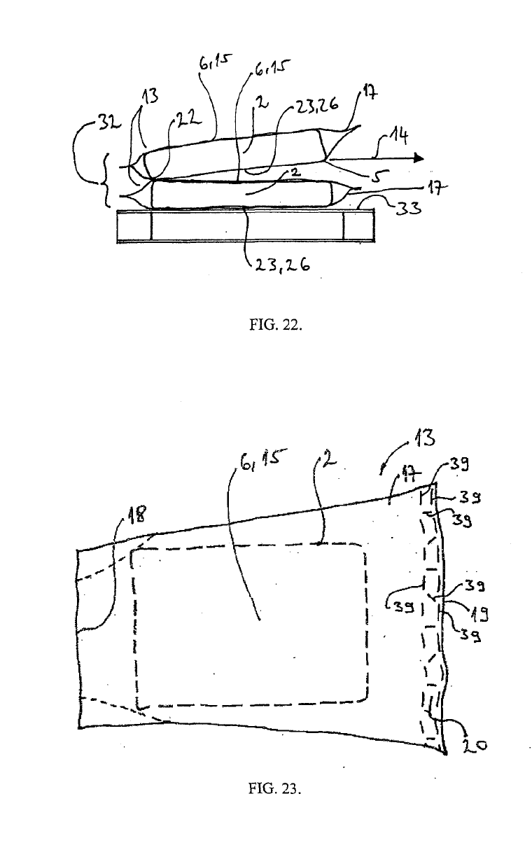

See FIGS. 21-22. Two packages 13 are provided, both according to Example 3. The stacking base 33 is a wooden pallet on the floor of a refrigerated hold in a trawler. The first package 13 is laid on the stacking base 33 with one of its flat sides, with its skidproofed surface-part 26 contacting the stacking base 33. The second package 13 is put on top of the first package 13, with centre-of-mass above centre-of-mass of the packages 13, forming a columnar stack 32. The skidproofed surface-part 26 of the second package 13 faces and contacts the roughened surface-part 15 of the first package 26. The contacting has an area great enough to keep the second package 13 from sliding on the first package 13 on tilting the stacking base 33 into a slanting orientation closing with the horizontal an angle of 60 degrees. Later a worker dismantles the formed stack 32, lifting a first edge 5 of the second package 13 simultaneously letting an opposing second edge 22 thereof abut on the first package 13 thereby rotating the second package 13, from a first orientation of the second package 13 into a second orientation of the second package 13, with an angle of about 7 degrees, and then keeping the second package 13 essentially in its second orientation while pulling the second package 13 at its first edge 5 off the first package 13 in a pulling direction 14. The top roughened surface-part 15 of the first package 13 remains in a suitably good condition for an antislip grip with a new skidproofed surface-part 26 of another package 13.

### Example 8: Method for Producing a Package 13

See FIG. 23. This Example method differs from that of Example 6 as follows. The mouth 19 of the sack 17 is closed with a specially patterned cross welding seam 20. The seam 20 is very near to the mouth 19, namely it is nearer to the mouth 19 than 10 mm's, thereby it is virtually impossible to manually grab the mouth 19 region of the sack 17 without also grabbing the seam 20, which prevents the seam 20 from possible separating mechanical overloads originating from dragging the package 13 grabbed at its mouth 19. For the welding, a patterned welding tool can be used having hot separating-wire sections, each of about 10 mm's in length, respectively, these hot sections not being contiguous with each other. The hot separating-wire sections, during the welding, form their respective separating-weld sections 39 in the sack 17. Thereby the welding pattern includes two lines of longitudinal intermittent series of separating-weld sections 39 parallel with each other and with the mouth 19, respective neighbouring separating-weld sections 39 separated by non-welded areas, the latter providing venting paths 38 for air through the seam 20. The welding pattern further includes a third intermittent series of separating-weld sections 39 (located centrally in between the mentioned two lines of longitudinal intermittent series of separating-weld sections 39) in which the respective separating-weld sections 39 have various respective orientations, including, among others, that perpendicular to the mouth 19. Each respective separating-weld section 39 of the seam 20 plays the role of a ripstop means, primarily against a ripping (i.e., a spreading separation of the sack 17 walls) coming from a direction perpendicular to the respective separating-weld section 39. Alternatively, the mentioned specially patterned cross welding seam 20 could be formed with ultrasonic welding, possibly with somewhat smaller respective separating-weld section 39 lengths. Further alternatively, the described pattern could be repeated beside one another, forming a wider welding seam 20.

1. A stackable package, comprising a packaging sack and a block of plate-frozen fish packed therein, wherein:
the sack is a plastic sack having a second outer surface, on which the package can be laid on a stack, and an opposing first outer surface, and
at least a part, the roughened surface-part, of the first outer surface comprising antislip protrusions projecting from a first wall of the sack, the first wall including a woven fabric, and
at least a part, the skidproofed surface-part, of the second outer surface comprising a skidproofing material, of a loose, fibrous structure, fixed, at least against slipping, to a second wall of the sack, which skidproofing material is capable of a nonslip bond with the antislip protrusions due to the antislip protrusions having suitable closeness and geometric features with respect to the skidproofing material and due to the skidproofing material including filaments or yarns in a density and layer thickness at which a mechanical bond can be formed between the filaments or yarns and the antislip protrusions, at least some of the antislip protrusions breaking the filament or yarn at a suitable load of the mechanical bond formed between the filament or yarn and the antislip protrusion,
the sack being suitable to pass a wear rate test with a result of a wear rate of between 0 and 0.35,
the wear rate test comprising the steps of:
providing a sled,
the sled having a rectangular flat surface on which the sled is suitable to slide in a sliding direction, the flat surface having a flat surface length of 20 mm parallel with the sliding direction, and a flat surface width of at least 20 mm in a direction perpendicular to the sliding direction,
providing a sled assembly by covering the sled flat surface in a suitably selected specimen of the sack second wall with the skidproofed surface-part providing a sliding surface of the sled assembly,
in a wearing operation bringing the sliding surface into a face-to-face relationship with a first area of a suitably selected specimen of the roughened surface-part and then maintaining a temperature of −20° C. in the sliding surface and the roughened surface-part specimen and a normal compression of 11557 Pa between them while sliding 40 mm's in the sliding direction the sled assembly on the roughened surface-part specimen for bringing the sliding surface into a face-to-face relationship with a third area of the roughened surface-part specimen,
in the roughened surface-part specimen the first area and the third area defining a second area therebetween, having antislip protrusions,
recording a first protrusion number equalling a number of the antislip protrusions available in the second area before the sliding and having a top-plan-view size greater than a limit size, the limit size being a half of an average of the respective top-plan-view sizes of each antislip protrusion available in the second area before the sliding,
recording a second protrusion number equalling the number of the antislip protrusions available in the second area after the sliding and having a top-plan-view size greater than the limit size,
defining the resulting wear rate equalling a difference, between the first protrusion number and the second protrusion number, divided by the first protrusion number.

2. The package according to claim 1, wherein, at least in one or more portions of the first wall, the first wall is free of a pressure sensitive adhesive layer between the woven fabric and the antislip protrusions.

3. The package (13) according to claim 1, wherein the antislip protrusions include polypropylene and/or the first wall includes polypropylene and/or the skidproofing material includes polypropylene.

4. The package according to claim 1, wherein in at least some antislip protrusions the antislip protrusion has a hidden surface portion being a portion of an outer surface of the antislip protrusion which the antislip protrusion covers from a viewer in a top plan view of the first wall taken from above the antislip protrusions.

5. The package according to claim 1, wherein a static friction between the roughened surface-part and the skidproofed surface-part is suitably high to resist sliding at a temperature of −20° C. in an inclined-plane-type static-friction test of 50 degrees angle according to the TAPPI T 815 standard.

6. The package according to claim 1, wherein the fish is unfilleted.

7. A method for producing a stackable package according to claim 1 including providing a packaging sack for packing a block of plate-frozen fish for producing a stackable package,
wherein:
the provided sack is a plastic sack having a second outer surface, on which the package can be laid on a stack, and an opposing first outer surface, and
at least a part, the roughened surface-part, of the first outer surface comprising antislip protrusions projecting from a first wall of the sack, the first wall including a woven fabric, and
at least a part, the skidproofed surface-part, of the second outer surface comprising a skidproofing material, of a loose, fibrous structure, fixed, at least against slipping, to a second wall of the sack, which skidproofing material is capable of a nonslip bond with the antislip protrusions due to the antislip protrusions having suitable closeness and geometric features with respect to the skidproofing material and due to the skidproofing material including filaments or yarns in such a density and layer thickness at which a mechanical bond can be formed between the filaments or yarns and the antislip protrusions, at least some of the antislip protrusions breaking the filament or yarn at a suitable load of the mechanical bond formed between the filament or yarn and the antislip protrusion,
the sack being suitable to pass a wear rate test with a result of a wear rate of between 0 and 0.35,
the wear rate test comprising the steps of:
providing a sled,
the sled having a rectangular flat surface on which the sled is suitable to slide in a sliding direction, the flat surface having a flat surface length of 20 mm parallel with the sliding direction, and a flat surface width of at least 20 mm in a direction perpendicular to the sliding direction,
providing a sled assembly by covering the sled flat surface in a suitably selected specimen of the sack second wall with the skidproofed surface-part providing a sliding surface of the sled assembly,
in a wearing operation bringing the sliding surface into a face-to-face relationship with a first area of a suitably selected specimen of the roughened surface-part and then maintaining a temperature of −20° C. in the sliding surface and the roughened surface-part specimen and a normal compression of 11557 Pa between them while sliding 40 mm's in the sliding direction the sled assembly on the roughened surface-part specimen for bringing the sliding surface into a face-to-face relationship with a third area of the roughened surface-part specimen,
in the roughened surface-part specimen the first area and the third area defining a second area therebetween, having antislip protrusions,
recording a first protrusion number equalling a number of the antislip protrusions available in the second area before the sliding and having a top-plan-view size greater than a limit size, the limit size being a half of an average of the respective top-plan-view sizes of each antislip protrusion available in the second area before the sliding,
recording a second protrusion number equalling the number of the antislip protrusions available in the second area after the sliding and having a top-plan-view size greater than the limit size,
defining the resulting wear rate equalling a difference, between the first protrusion number and the second protrusion number, divided by the first protrusion number.

8. The method according to claim 7, wherein, at least in one or more portions of the first wall, the first wall is free of a pressure sensitive adhesive layer between the woven fabric and the antislip protrusions.

9. The method according to claim 7, wherein in the provided sack the antislip protrusions include polypropylene and/or the first wall includes polypropylene and/or the skidproofing material includes polypropylene.

10. The method according to claim 7, wherein in the provided sack in at least some antislip protrusions the antislip protrusion has a hidden surface portion being a portion of an outer surface of the antislip protrusion which the antislip protrusion covers from a viewer in a top plan view of the first wall taken from above the antislip protrusions.

11. The method according to claim 7, wherein in the provided sack a static friction between the roughened surface-part and the skidproofed surface-part is suitably high to resist sliding at a temperature of −20° C. in an inclined-plane-type static-friction test of 50 degrees angle according to the TAPPI T 815 standard.

12. The method according to claim 7, wherein the method further includes providing a block of plate-frozen fish and packing the block into the sack for providing a stackable package.

13. The method according to claim 12, wherein the provided block contains unfilleted fish.

14. The method according to claim 12, wherein the method further includes closing the package with making a seam across the sack with welding, providing venting paths for air through the seam.

15. A method for using stackable packages including providing a first package and a second package and a stacking base, forming a stack from the packages including laying the first package on the stacking base and placing the second package upon the first package,
wherein:
each of the first and second packages is provided according to claim 1, and the forming of the stack includes, for providing an antislip grip between the packages, at least one of:
laying the skidproofed surface-part of the second package upon the roughened surface-part of the first package and
laying the roughened surface-part of the second package upon the skidproofed surface-part of the first package.

16. The method according to claim 15, wherein the provided antislip grip is suitable to keep the second package from sliding on the first package on tilting the stacking base into a slanting orientation closing with the horizontal an angle of 35 degrees.

17. The method according to claim 15, wherein the stack is formed aboard a vessel.

18. The method according to claim 15, wherein the forming of the stack includes laying the skidproofed surface-part of the second package upon the roughened surface-part of the first package and the method further includes, for a dismantling of the formed stack, lifting a first edge of the second package simultaneously letting an opposing second edge thereof abut on the first package thereby rotating the second package, from a first orientation of the second package into a second orientation of the second package, with an angle of between 1 degree and 50 degrees, and then keeping the second package essentially in its second orientation while sliding the second package on the first package.
